(19) United States
(12) Patent Application Publication
(10) Pub. No.: US 2025/0246194 A1
(43) Pub. Date: Jul. 31, 2025

(54) METHOD AND APPARATUS FOR VOICE RECOGNITION USING ARTIFICIAL INTELLIGENCE

(71) Applicant: IUCF-HYU (INDUSTRY-UNIVERSITY COOPERATION FOUNDATION HANYANG UNIVERSITY), Seoul (KR)

(72) Inventors: JoonHyuk CHANG, Seoul (KR); MunHak LEE, Seoul (KR); SangEon LEE, Seoul (KR); JiEun CHOI, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/034,769

(22) Filed: Jan. 23, 2025

(30) Foreign Application Priority Data
Jan. 25, 2024 (KR) 10-2024-0011694

(51) Int. Cl. G10L 15/26; G10L 15/16

(52) U.S. Cl. CPC G10L 15/26; G10L 15/16

(57) ABSTRACT

A method performed by an electronic device using artificial intelligence according to an embodiment of the disclosure, the method may include: receiving a first speech signal; and outputting a first text corresponding to the first speech signal from a pre-trained first artificial intelligence algorithm module using the first speech signal as input, wherein the pre-trained first artificial intelligence algorithm module is pre-trained based on a first loss, and wherein the first loss is determined based on a similarity between at least one speech embedding output from the first artificial intelligence algorithm module using a second speech signal as input and at least one text embedding output from a second artificial intelligence algorithm module using a second text as input.

### CROSS-REFERENCE TO RELATED APPLICATIONS

This application claims the benefits of Korean Patent Application No. 10-2024-0011694, filed on Jan. 25, 2024, in the Korean Intellectual Property Office, the disclosures of which are incorporated herein in their entireties by reference.

### BACKGROUND

### 1. Field

The disclosure relates to a method and an apparatus for recognizing speech using artificial intelligence.

### 2. Description of the Related Art

The disclosure relates to a method and an electronic device for improving a performance of a speech recognition model by enhancing speech recognition capabilities.

Recently, speech recognition technology that collects speech signals and processes them into data has emerged. Speech recognition technology refers to a technology that allows human speech to be processed in a text format through programs. The speech recognition programs may understand and process a speaker's grammar, syntax, structure, and so on.

In speech recognition systems, training is performed using data sets consisting of speech-transcription (text) pairs, and the amount of collected data is used as a very important factor in the performance of speech recognition models. However, there is a problem that collecting large speech-transcription datasets requires a significant time and cost investment.

### SUMMARY

Provided are a method and an apparatus for improving a performance of a speech recognition model.

Provided is a method for improving a performance of a speech recognition model through cross-modal learning based on a speech recognition model and a language model.

According to an embodiment of the disclosure, a method performed by an electronic device using artificial intelligence comprises: receiving a first speech signal; and outputting a first text corresponding to the first speech signal from a pre-trained first artificial intelligence algorithm module using the first speech signal as input, wherein the pre-trained first artificial intelligence algorithm module is pre-trained based on a first loss, and wherein the first loss may be determined based on a similarity between at least one speech embedding output from the first artificial intelligence algorithm module using a second speech signal as input and at least one text embedding output from a second artificial intelligence algorithm module using a second text as input.

In an embodiment, the first artificial intelligence algorithm module may include a CTC (connectionist temporal classification) model, and the second artificial intelligence algorithm module may include a BERT (bidirectional encoder representations from transformers) model.

In an embodiment, the first loss may be determined based on a CTC-BERT score, which is determined based on an average value of the similarity between the at least one speech embedding and the at least one text embedding.

In an embodiment, the pre-trained first artificial intelligence algorithm module may be further pre-trained based on the first loss and a second loss, and wherein the second loss may be determined based on a reference token sequence output from the first artificial intelligence algorithm module using the second speech signal as input.

In an embodiment, the second artificial intelligence algorithm module may be pre-trained and have a fixed model parameter.

In an embodiment, the CTC-BERT score may be determined as follows,

$${R}_{C , B} ( x , y ) = \frac{1}{T} {\sum }_{{[ {h}^{X} ]}_{i} ∈ {h}^{X}} {max}_{{[ {h}^{Y} ]}_{j} ∈ {h}^{Y}} {Φ}_{ij} ,$$

$${R}_{C , B} ( x , y ) = \frac{1}{U} {\sum }_{{[ {h}^{Y} ]}_{i} ∈ {h}^{Y}} {max}_{{[ {h}^{X} ]}_{i} ∈ {h}^{X}} {Φ}_{ij} ,$$

$${Φ}_{ij} = \frac{{{[ {h}^{X} ]}_{i}^{T} [ {h}^{Y} ]}_{j}}{‖ {[ {h}^{X} ]}_{i} ‖ ‖ {[ {h}^{Y} ]}_{i} ‖}$$

wherein T represents a length of the second speech signal, and wherein U represents a length of the second text.

In an embodiment, the first loss may be determined by the following equation,

$${ℒ}_{CMWED} = {\sum }_{m = 1}^{M} - {p}_{m}^{ψ} log {p}_{m}^{{P}_{C , B}} ,$$

$${p}_{m}^{ψ} = \frac{{ψ}_{m}}{{\sum }_{i = 1}^{M} {ψ}_{i}^{′}}$$

$${p}_{m}^{{P}_{C , B}} = \frac{{P}_{C , B} ( x , {\dot{y}}_{m} )}{{\sum }_{i = 1}^{M} {P}_{C , B} ( x , {\dot{y}}_{i} )}$$

$$wherein$$

$${ψ}_{m} = exp ( - \frac{{d}_{m}}{τ max ( \vert y \vert , \vert {\dot{y}}_{m} \vert )} ) .$$

According to an embodiment of the disclosure, the disclosure an electronic device includes: a memory; a modem; and a processor connected to the modem and the memory, wherein the processor is configured to: receive a first speech signal, and output a first text corresponding to the first speech signal from a pre-trained first artificial intelligence algorithm module using the first speech signal as input, wherein the pre-trained first artificial intelligence algorithm module is pre-trained based on a first loss, and wherein the first loss may be determined based on a similarity between at least one speech embedding output from the first artificial intelligence algorithm module using a second speech signal as input and at least one text embedding output from a second artificial intelligence algorithm module using a second text as input.

According to an embodiment of the disclosure, a program stored on a medium for performing speech recognition through an artificial intelligence algorithm executable by a processor, the program includes: receiving a first speech signal; and outputting a first text corresponding to the first speech signal from a pre-trained first artificial intelligence algorithm module using the first speech signal as input, wherein the pre-trained first artificial intelligence algorithm module is pre-trained based on a first loss, and wherein the first loss may be determined based on a similarity between at least one speech embedding output from the first artificial intelligence algorithm module using a second speech signal as input and at least one text embedding output from a second artificial intelligence algorithm module using a second text as input.

According to an embodiment of the disclosure, a performance of a speech recognition model may be improved through a newly proposed evaluation method based on a similarity of sequence pairs.

According to an embodiment of the disclosure, time and monetary costs may be reduced by improving a performance of a speech recognition model in a direction of enhancing an evaluation score through a cross-modal learning method.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram illustrating the basic principles of an artificial intelligence structure according to an embodiment of the disclosure.

FIG. 2 is a diagram illustrating a speech recognition model according to an embodiment of the disclosure.

FIG. 3 is a diagram illustrating a process of performing training in a speech recognition system according to an embodiment of the disclosure.

FIG. 4 is a diagram illustrating a CTC-BERT scoring method according to an embodiment of the disclosure.

FIG. 5 is a block configuration diagram of an electronic device to which an artificial intelligence algorithm model is applied according to an embodiment of the disclosure.

FIG. 6 is a flowchart illustrating a method of performing speech recognition according to an embodiment of the disclosure.

### DETAILED DESCRIPTION

The disclosure may be variously modified and have various embodiments, so that specific embodiments will be illustrated in the drawings and described in the detailed description. However, this does not limit the disclosure to specific embodiments, and it should be understood that the disclosure covers all the modifications, equivalents and replacements included within the idea and technical scope of the disclosure.

In explaining the disclosure, in the following description, a detailed explanation of known related technologies may be omitted to avoid unnecessarily obscuring the subject matter of the disclosure. In addition, numeral figures (for example, 1, 2, and the like) used during describing the disclosure are just identification symbols for distinguishing one element from another element.

Further, in the disclosure, if it is described that one component is “connected” or “accesses” the other component, it is understood that the one component may be directly connected to or may directly access the other component but unless explicitly described to the contrary, another component may be “connected” or “access” between the components.

In addition, terms including “unit”, “er”, “or”, “module”, and the like disclosed in the disclosure mean a unit that processes at least one function or operation and this may be implemented by hardware or software such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software, this also may be implemented in a form that is combined with memory which stores data necessary for processing at least one function or operation.

Moreover, it is intended to clarify that components in the disclosure are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

In the description of the embodiments, certain detailed explanations of a related function or configuration are omitted when it is deemed that they may unnecessarily obscure the essence of the disclosure. In addition, the terms described below are defined in consideration of the functions in the disclosure, and may vary depending on the intention or custom of a user or an operator. Therefore, the definition needs to be made based on content throughout this specification.

For the same reason, some components may be exaggerated, omitted, or schematically shown in the accompanying drawings. In addition, the size of each component does not entirely reflect its actual size. In each drawing, identical or corresponding components are given the same reference numerals.

The advantages and features of the disclosure and a method of achieving them will become clear by referring to the embodiments described in detail below along with the accompanying drawings. However, the disclosure is not limited to the embodiments disclosed below, but may be implemented in various different forms. The embodiments are provided to ensure that the description of the disclosure is complete and to fully inform one of ordinary skill in the art of the scope of the disclosure, and the claimed scope of the disclosure is only defined by the scope of the claims.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some Alternative implementations, it is possible for functions mentioned in the blocks to occur out of order. For example, two blocks shown in succession may be performed substantially simultaneously, or the blocks may sometimes be performed in reverse order depending on their corresponding functions.

The term “unit or part” used in the disclosure refers to software or hardware components such as a field-programmable gate array (FPGA) or an application specific integrated circuit (ASIC), and the “unit or part” may be configured to perform specific roles. However, the “unit or part” is not limited to software or hardware. The “unit or part” may be configured to be stored in an addressable storing medium or to execute one or more processors. Accordingly, the “unit or part” may include, for example, software components, object-oriented software components, components such as class components and task components, processors, formulas, attributes, procedures, subroutines, segments of program code, drivers, firmware, micro code, circuits, data, database, data structures, tables, arrays and variables. Functions provided in components and “units or parts” may be combined into a smaller number of components and “units or parts”, or may be further divided into additional components and “units or parts.” Furthermore, components and “units or parts” may be implemented to reproduce one or more central processing units within a device or a secure multimedia card. In addition, in an embodiment, “unit or part” may include one or more processors and/or devices.

Hereinafter, embodiments will be described in detail in order.

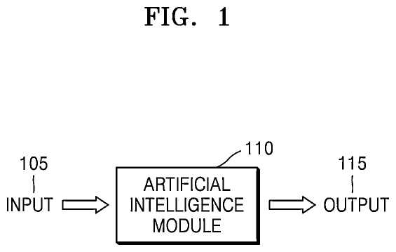

FIG. 1 is a conceptual diagram illustrating the basic principles of an artificial intelligence structure according to an embodiment of the disclosure.

Referring to FIG. 1, the basic principles of how learning is performed in an artificial intelligence structure are illustrated.

Artificial intelligence technology refers to technology for solving cognitive problems primarily associated with human intelligence, such as learning, problem-solving, and recognition. Artificial intelligence may be trained through machine learning (ML) methods and deep learning (DL) methods. Machine learning is primarily used in techniques for pattern recognition and learning, and refers to algorithms that learn from recorded data to predict subsequent data based on the result of the learning. Additionally, machine learning refers to technology that learns by itself from data without being based on predefined rules or patterns. In contrast, deep learning is a field of machine learning with the difference that deep learning processes data based on Artificial Neural Networks (ANN). Since deep learning uses artificial neural networks, deep learning may process more complex and sophisticated computations than machine learning. Types of algorithms for deep learning may include Convolutional Neural Networks (CNN), Artificial Neural Networks (ANN), and Recurrent Neural Networks (RNN).

Referring to FIG. 1, the artificial intelligence structure may be represented by an artificial intelligence module 110. The artificial intelligence module 110 receives predetermined input data 105, performs learning through a predetermined method defined in the module, and outputs output data 115 through algorithms according to the learning results. According to an embodiment, the input data 105 may include predetermined data, audio signals, speech signals, text, etc. The output data 115 may include text information corresponding to speech signals, speech embeddings, text embeddings, output sequences, etc.

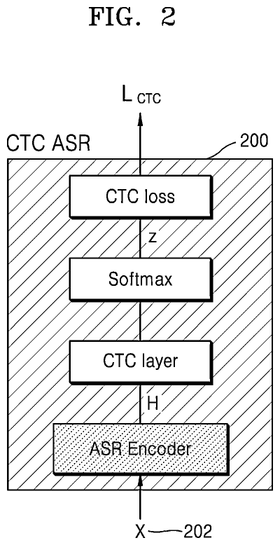

FIG. 2 is a diagram illustrating a speech recognition model according to an embodiment of the disclosure.

A CTC (Connectionist Temporal Classification) structure 200 shown in FIG. 2 may be one of the types of artificial intelligence module 110 shown in FIG. 1.

Referring to FIG. 2, the overall artificial intelligence algorithm structure according to an embodiment of the disclosure may include the CTC structure 200.

According to an embodiment, the CTC structure 200, also called CTC ASR (Automatic Speech Recognition), may represent a model that converts input speech signals into text sequences. That is, the CTC structure 200 may represent an end-to-end speech recognition system that predicts target sequences from input speech. The CTC 200 based speech recognition system may perform speech recognition functions without explicit alignment information between the input speech sequence and the target sequence. The CTC structure 200 may consider probability distributions for all possible sequences. That is, the CTC structure 200 may consider the probability distribution of all possible output sequences for a given input speech sequence. The equation for calculating the probability distribution is as follows:

$${P}_{CTC} ( a \vert X ) \approx {\prod }_{t = 1}^{\vert a \vert} P ( {a}_{t} \vert X ) \qquad [ Equation 1 ]$$

In Equation 1, X represents an input sequence, aₜ represents a token at time step t in alignment a, and |a| may represent a length of alignment a.

Referring to FIG. 2, the CTC structure 200 may determine a loss of the algorithm through ASR encoder, CTC layer, Softmax operation, and CTC loss calculation using the speech sequence X 202 as input and may perform training of the algorithm model based on the loss.

However, the CTC structure may be limited by the assumption that a correlation between tokens is not modeled. To overcome this limitation, a language model (LM) may be used. A language model specializes in approximation and may effectively approximate probability distributions and may effectively improve the performance of the CTC model 200 through a decoding method. In this approach, a method has been researched where external language model is not used in the decoding process, but a pre-trained language model is used to induce the CTC model itself to better incorporate long-range semantic information.

Accordingly, a method of jointly training the CTC 200 model and the BERT (bidirectional encoder representations from transformers) model was proposed, and additionally, a method of training the CTC model by mimicking representations generated by BERT according to a cross-modal knowledge distillation scenario was researched. Through these methods, the limitations of the CTC model may be mitigated, and generalization performance may be improved.

The CTC structure 200 of FIG. 2 is not limited to the structure shown, and it is understood that any structure of a model capable of performing speech recognition may be included in the CTC structure 200. Contents not described in detail in FIG. 2 are widely known in the field of artificial intelligence speech recognition technology and may be understood through the figures, so they will not be described further.

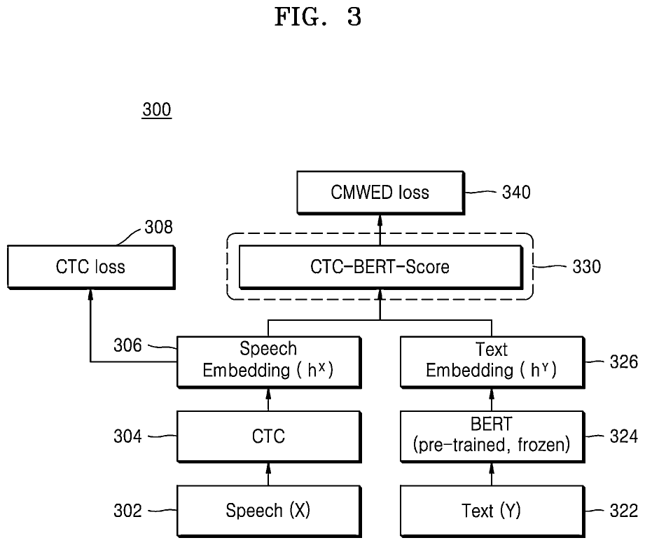

FIG. 3 is a diagram illustrating a process of performing training in a speech recognition system according to an embodiment of the disclosure.

A CTC model 304 included in a speech recognition system 300 of FIG. 3 may be identical or similar to the CTC structure 200 of FIG. 2. A BERT model 324 included in the speech recognition system 300 of FIG. 3 may be identical or similar to the BERT model described in FIG. 2.

FIG. 3 may represent an artificial intelligence algorithm model that learns using a cross-modal learning technique. Here, the cross-modal learning technique may represent a method of training a neural network model with two or more types of datasets. In FIG. 3, a method of performing cross-modal learning using speech datasets and text datasets is proposed. In this case, learning may be performed by assuming a source modality with relatively abundant datasets and a target modality with relatively few datasets.

In FIG. 3, speech may be utilized in the target modality, and text may be utilized in the source modality. This is because collecting actual text data is relatively easier. In FIG. 3, the performance of a language model trained with the source modality (i.e., text) may be transferred to the speech recognition model. Through this method, the performance of a speech recognition model trained with a small number of speech-transcript pairs may be improved.

The cross-modal learning method may be a method of learning a correlation between instances with different forms by utilizing the neural network model when speech (X) 302 and text (Y) 322, which are instantiated in two different forms, is given. The cross-modal learning method may be largely composed of 4 steps.

First, speech representation vector h_{X}=g_{X}(f_{X}(x)) may be generated in a fine-grained latent space of dimension (d_{H}) using a modality-specific encoder (f_{X}:X [symbol] [symbol] ) and mapping function g_{X}: [symbol] [symbol] [symbol] .

Second, text representation vector h^{Y}=g_{Y}(f_{Y}(y)) may be generated in the same way using a modality-specific encoder (f_{Y}:Y [symbol] [symbol] ) and mapping function g_{Y}: [symbol] [symbol] [symbol] .

Third, a similarity function S(-,-) may be used to estimate a similarity between the two representation vectors.

Fourth, the artificial intelligence network model may perform training in the direction of increasing a similarity between positive pairs and perform training in the direction of decreasing a similarity between negative pairs.

The above cross-modal method may be applied to the CTC-based speech recognition model. First, task-specific encoders specialized in speech and text encoding may be determined and a similarity measurement between two sequences of different lengths may be defined. Then, an appropriate objective function for updating a CTC model parameter may be designed.

The BERT model 324 may represent a language model with the structure of a transformer encoder trained using a masked word prediction method. Due to the characteristics of the transformer-based model structure and masked word prediction method, the BERT model 324 may perform well in embedding long-range semantic information.

The speech recognition system 300 may include a method of evaluating the quality of a candidate sentence generated by a conditional language generation model through the BERT score method. The BERT score method evaluates quality based on the similarity between latent space representations by transmitting a tokenized reference sentence and a tokenized candidate sentence.

A Minimum Word Error Rate (MWER) loss may be defined as follows:

$${ℒ}_{MWER} = {\sum }_{m = 1}^{M} {p}_{m} \cdot ( {d}_{m} - \overline{d} ) , \qquad [ Equation 2 ]$$

$${p}_{m} = \frac{{e}^{- {s}_{m}}}{{\sum }_{i = 1}^{M} {e}^{- {s}_{i}}} ,$$

$$\overline{d} = \frac{1}{M} {\sum }_{m = 1}^{M} {d}_{m} ,$$

Here, Sₘ may represent a sequence-level score estimated by the speech recognition model. MWER represents an objective function designed to minimize the expected edit distance for hypotheses. However, due to the MWER loss, there is a high probability that mass will be assigned only to a correct sequence, which may cause an overestimation problem. Therefore, a new sequence-level objective function called Matching Word Error Distribution (MWED) may be proposed.

$${ℒ}_{MWED} = - {\sum }_{m = 1}^{M} {p}_{m}^{d} log {p}_{m}^{s} , \qquad [ Equation 3 ]$$

$${p}_{m}^{d} = \frac{{e}^{{d}_{m}}}{{\sum }_{i = 1}^{M} {e}^{{d}_{j}}} ,$$

$${p}_{m}^{s} = \frac{{e}^{{s}_{i} / τ}}{{\sum }_{j = 1}^{M} {e}^{{s}_{j} / τ}}$$

Here, τ may represent a tuning factor greater than 0. The MWED loss may be used to train by minimizing the cross-entropy between the target probability distribution transformed from the edit distance for each hypothesis and the sequence-level score distribution estimated by the artificial intelligence network. Unlike MWER, MWED may evenly distribute the estimated probability mass in proportion to the accuracy of the hypothesis.

The speech recognition system of FIG. 3 may use a cross-modal learning method and evaluate it using a CTC-BERT scoring method. The CTC-BERT scoring method is an improved performance by modifying the BERT scoring method described earlier. To perform the cross-modal learning method, appropriate scoring functions and loss functions must be determined, and the CTC-BERT scoring method may be used as the scoring function.

In the CTC-BERT scoring method, paired speech (X) 302 and text (Y) 322 samples are determined as h^{X}=g_{X}(f_{CTC}(x)), and h^{Y}=g_{Y}(f_{BERT}(y; l_{BERT})). Here f_{CTC}:X [symbol] [symbol] _{CT} represents the CTC model 304, and f_{BERT}:Y [symbol] [symbol] ^{BERT} represents the BERT model 324. g_{X}: [symbol] ^{CTC} [symbol] [symbol] and g_{Y}: [symbol] ^{BERT} [symbol] [symbol] may represent learnable mapping functions. Here, T represents a length of the speech, and U may represent a length of the token sequence (or text).

The CTC-BERT scoring method may be defined as the following equation:

$${R}_{C , B} ( x , y ) = \frac{1}{T} {\sum }_{{[ {h}^{X} ]}_{i} ∈ {h}^{X}} {max}_{{[ {h}^{Y} ]}_{j} ∈ {h}^{Y}} {Φ}_{ij} , \qquad [ Equation 4 ]$$

$${P}_{C , B} ( x , y ) = \frac{1}{U} {\sum }_{{[ {h}^{Y} ]}_{j} ∈ {h}^{Y}} {max}_{{[ {h}^{X} ]}_{i} ∈ {h}^{X}} {Φ}_{ij} ,$$

$${Φ}_{ij} = \frac{{{[ {h}^{X} ]}_{i}^{T} [ {h}^{Y} ]}_{j}}{‖ {[ {h}^{X} ]}_{i} ‖ ‖ {[ {h}^{Y} ]}_{j} ‖}$$

Here, [h^{X}]ᵢ may represent a representation vector of the i-th time step in h^{X}.

f_{CTC}( ) is a function that takes speech as input and generates a second layer output of d_{ctc} dimension, and f_{BERT}( ) may be a function that takes a token sequence as input and generates a representation vector of the l_{BERT}-th layer of BERT. The mapping functions g_{X} and g_{Y} perform the role of matching the dimensions of representation vectors generated by CTC and BERT respectively and may be composed of one layer of a learnable fully connected layer.

Based on the CTC-BERT scoring method, an objective function for learning correlations between positive pairs and negative pairs may be determined. The CTC-BERT scoring method may estimate similarity between speech and text at the sequence level. Therefore, it is desirable to utilize a sequence-level objective function in model training. Thus, an objective function (CMWED) that modifies the MWED loss may be utilized.

CMWED may represent a cross-modal MWED. The CMWED may be represented as follows:

$${ℒ}_{CMWED} = {\sum }_{m = 1}^{M} - {p}_{m}^{ψ} log {p}_{m}^{{P}_{C , B}} , \qquad [ Equation 5 ]$$

$${p}_{m}^{ψ} = \frac{{ψ}_{m}}{{\sum }_{i = 1}^{M} {ψ}_{i}} ,$$

$${p}_{m}^{{P}_{C , B}} = \frac{{P}_{C , B} ( x , {\dot{y}}_{m} )}{{\sum }_{i = 1}^{M} {P}_{C , B} ( x , {\dot{y}}_{i} )}$$

Here, a edit distance-based sequence-level similarity may be expressed as

$${ψ}_{m} = exp ( - \frac{{d}_{m}}{τ max ( \vert y \vert , \vert {\dot{y}}_{m} \vert )} ) .$$

The CTC-BERT score for the m-th hypothesis ym in the hypothesis set may be represented as (P_{CB}(x,\dot{y}ₘ) or R_{C.B}(x, \dot{y}ₘ)).

A CMWED loss may be used to match the similarity between the latent space representation vector of speech and the hypothesis text with the edit distance-based similarity distribution. During the training process, only the parameters of CTC and the mapping function are updated, and the parameter of the trained BERT may not be updated. The model of the speech recognition system may be trained using a gradient descent method by summing the CMWED loss and the CTC loss. The total loss may be determined by the following equation:

$${ℒ}_{total} = {ℒ}_{CTC} + {αℒ}_{CMWED} \qquad [ Equation 6 ]$$

Here, α may represent a hyperparameter. The CTC model may estimate the probability distribution of character presence per frame and be trained with CTC loss targeting reference token sequences. Additionally, the output of the CTC model is generated by passing the second layer output of the CTC model to a modality-specific encoder and may perform training using the proposed CMWED loss. That is, the CTC model of FIG. 3 may be trained through a multi-task learning scenario using Lₜₒₜₐₗ.

Based on the above content, referring to FIG. 3, the process by which the speech recognition system 300 performs training by determining the CTC-BERT scoring method, CTC loss, and CMWED loss may be explained. First, the speech recognition system 300 may include a CTC structure 304 and a BERT model 324. Here, the BERT model 324 may be pre-trained with a fixed parameter. The speech signal 302 may be input to the CTC structure 304. When the speech signal 302 is input, the CTC structure 304 may output a speech embedding (h^{X}) 306. The CTC structure 304 may determine CTC loss 308 based on the input speech signal 302 and the output speech embedding 306. A text 322 may be input to the BERT model 324. The BERT model 324 may output a text embedding (h^{Y}) 326 based on the input text 322. The speech recognition system 300 may perform CTC-BERT score calculation 330 using the output speech embedding 306 and text embedding 326. The CTC-BERT score calculation 330 may be determined through [Equation 4] described earlier. The speech recognition system 300 may determine CMWED loss 340 through the method shown in [Equation 5] based on the similarity obtained through the CTC-BERT score calculation 330. The speech recognition system 300 may perform training using the determined CTC loss 308 and CMWED loss 340. When training is performed, training may proceed in the direction that maximizes the CTC-BERT score.

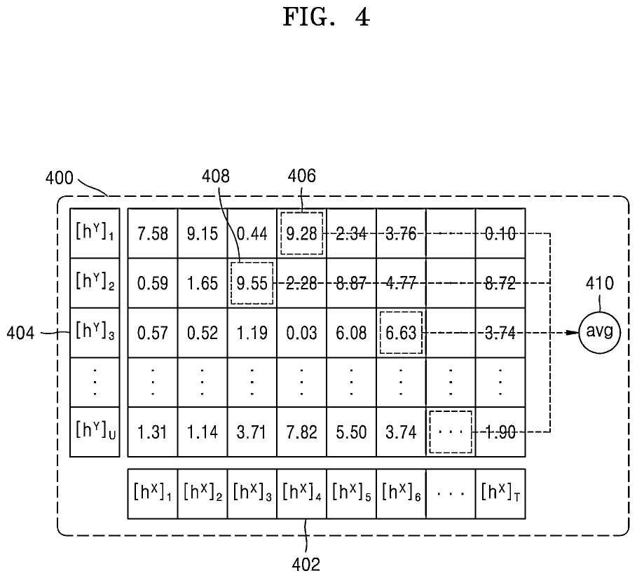

FIG. 4 is a diagram illustrating a CTC-BERT scoring method according to an embodiment of the disclosure.

A CTC-BERT score calculation 400 of FIG. 4 may be identical or similar to the CTC-BERT score calculation 330 of FIG. 3.

Referring to FIG. 4, the text representation embeddings 404 of the length U and speech embeddings 402 of the length T may be input to the CTC-BERT score calculation 330. Additionally, the similarity between the text representation embeddings 404 and the speech representation embeddings 402 may be determined. For example, the similarity 406 between the first text representation embedding and the fourth speech representation embedding is shown as 9.28, which may be confirmed as representing the highest similarity that may be obtained from the first text representation embedding. Furthermore, the similarity 408 between the second text representation embedding and the third speech representation embedding is shown as 9.55, which may be confirmed as representing the highest similarity that may be obtained from the second text representation embedding. Therefore, through comparison of similarities between each text representation embedding and speech representation embeddings from 1 to U, the largest values may be determined, and the average value 410 may be determined. Based on this method, P_{C.B}(x,y) and R_{C.B}(x,y) of Equation 4 described in FIG. 3 may be determined.

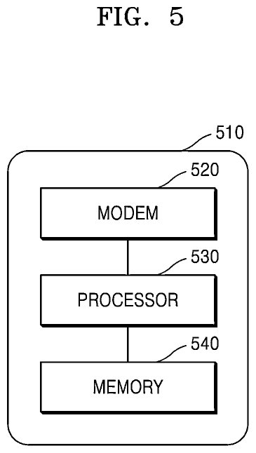

FIG. 5 is a block diagram of an electronic device to which an artificial intelligence algorithm model is applied according to an embodiment of the disclosure.

FIG. 5 is a block diagram of an electronic device with an applied artificial intelligence algorithm model according to an embodiment of the disclosure.

Referring to FIG. 5, the electronic device 510 may include a modem 520, memory 540, and processor 530.

The modem 520 may be a communication modem that is electrically connected to other electronic devices to enable mutual communication. In particular, the modem 520 may receive data input and transmit it to the processor 530, and the processor 530 may store the input data values in the memory 540. Additionally, the modem 520 may transmit information output by the learned artificial intelligence algorithm in the system to other electronic devices.

The memory 540 is a component where various information and program instructions for the operation of the electronic device 510 are stored, and the memory 540 may be a storage device such as a Hard Disk or Solid State Drive (SSD). In particular, the memory 540 may store one or more data input values from the modem 520 under the control of the processor 530. Furthermore, the memory 540 may store program instructions executable by the processor 530, such as artificial intelligence algorithms for speech recognition.

The processor 530 comprises at least one processor and may learn speech recognition artificial intelligence algorithms and cross-modal speech recognition artificial intelligence algorithms using the data and program instructions stored in the memory 540 and utilize these to calculate data. The processor 530 may control and calculate all artificial intelligence algorithms (for example, speech recognition algorithm models, speech recognition systems trained using the CTC-BERT score method, artificial intelligence algorithm models) described in FIG. 1 through FIG. 4.

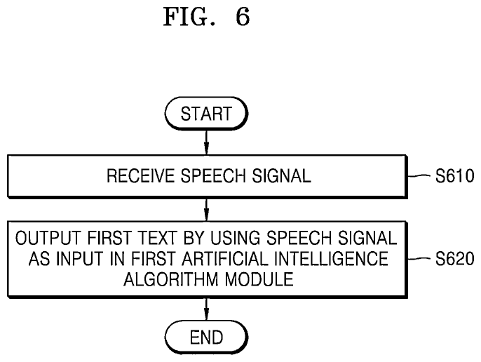

FIG. 6 is a flowchart illustrating a method of performing speech recognition according to an embodiment of the disclosure.

Referring to FIG. 6 below, the artificial intelligence algorithm training operation, speech recognition method, and CTC-BERT score method training method of the electronic device described with reference to FIG. 1 through FIG. 5 are summarized and explained. Each operation is not necessarily required to be included in the sequential process and may operate with only some components depending on the situation.

In step S610, the electronic device may receive a speech signal (for example, the speech sequence 202 of FIG. 2 or the speech 302 of FIG. 3).

In step S620, using the speech signal as input, a first artificial intelligence algorithm module (for example, the CTC structure 200 of FIG. 2 or the CTC model 304 of FIG. 3) may output text corresponding to the speech signal (for example, the speech embedding 306 of FIG. 3).

According to an embodiment, the pre-trained first artificial intelligence algorithm module may be pre-trained based on a first loss (for example, the CMWED loss 340 of FIG. 3), and the first loss may be determined based on the similarity (for example, the similarities 406, 408 of FIG. 4) between at least one speech embedding (for example, the speech embedding 306 of FIG. 3) output from the first artificial intelligence algorithm module using a second speech signal (for example, the speech 302 of FIG. 3) as input and at least one text embedding (for example, the text embedding 326 of FIG. 3) output from a second artificial intelligence algorithm module (for example, the BERT model 324 of FIG. 3) using a second text (for example, the text 322 of FIG. 3) as input.

According to an embodiment, the first artificial intelligence algorithm module may include a CTC (connectionist temporal classification) model, and the second artificial intelligence algorithm module may include a BERT (bidirectional encoder representations from transformers) model.

According to an embodiment, the first loss may be determined based on a CTC-BERT score determined based on the average value (for example, the average value 410 of FIG. 4) of the similarity between the at least one speech embedding and the at least one text embedding.

According to an embodiment, the pre-trained first artificial intelligence algorithm module may be further pre-trained based on the first loss and a second loss (for example, the CTC loss of FIG. 2 or the CTC loss 308 of FIG. 3), and the second loss may be determined based on a reference token sequence output from the first artificial intelligence algorithm module using the second speech signal as input.

According to an embodiment, the second artificial intelligence algorithm module may be pre-trained with a fixed model parameter.

Although the inventive concept of the disclosure has been described in detail through various embodiments, the inventive concept of the disclosure is not limited to the above embodiments, and various modifications and changes are possible by those skilled in the art within the scope of the inventive concept of the disclosure.

What is claimed is:

1. A method performed by an electronic device using artificial intelligence, comprising:
receiving a first speech signal; and
outputting a first text corresponding to the first speech signal from a pre-trained first artificial intelligence algorithm module using the first speech signal as input,
wherein the pre-trained first artificial intelligence algorithm module is pre-trained based on a first loss, and
wherein the first loss is determined based on a similarity between at least one speech embedding output from the first artificial intelligence algorithm module using a second speech signal as input and at least one text embedding output from a second artificial intelligence algorithm module using a second text as input.

2. The method of claim 1,
wherein the first artificial intelligence algorithm module includes a CTC (connectionist temporal classification) model, and
wherein the second artificial intelligence algorithm module includes a BERT (bidirectional encoder representations from transformers) model.

3. The method of claim 1,
wherein the first loss is determined based on a CTC-BERT score, which is determined based on an average value of the similarity between the at least one speech embedding and the at least one text embedding.

4. The method of claim 1,
wherein the pre-trained first artificial intelligence algorithm module is further pre-trained based on the first loss and a second loss, and
wherein the second loss is determined based on a reference token sequence output from the first artificial intelligence algorithm module using the second speech signal as input.

5. The method of claim 1,
wherein the second artificial intelligence algorithm module is pre-trained and has a fixed model parameter.

6. The method of claim 3,
wherein the CTC-BERT score is determined as follows,
$${R}_{C , B} ( x , y ) = \frac{1}{T} {\sum }_{{[ {h}^{X} ]}_{i} ∈ {h}^{X}} {max}_{{[ {h}^{Y} ]}_{j} ∈ {h}^{Y}} {Φ}_{ij} ,$$
$${P}_{C , B} ( x , y ) = \frac{1}{U} {\sum }_{{[ {h}^{Y} ]}_{j} ∈ {h}^{Y}} {max}_{{[ {h}^{X} ]}_{i} ∈ {h}^{X}} {Φ}_{ij} ,$$
$${Φ}_{ij} = \frac{{{[ {h}^{X} ]}_{i}^{T} [ {h}^{Y} ]}_{j}}{‖ {[ {h}^{X} ]}_{i} ‖ ‖ {[ {h}^{Y} ]}_{j} ‖}$$
wherein T represents a length of the second speech signal,
and wherein U represents a length of the second text.

7. The method of claim 6,
wherein the first loss is determined by the following equation,
$${ℒ}_{CMWED} = {\sum }_{m = 1}^{M} - {p}_{m}^{ψ} log {p}_{m}^{{P}_{C , B}} ,$$
$${p}_{m}^{ψ} = \frac{{ψ}_{m}}{{\sum }_{i = 1}^{M} {ψ}_{i}} ,$$
$${p}_{m}^{{P}_{C , B}} = \frac{{P}_{C , B} ( x , {\dot{y}}_{m} )}{{\sum }_{i = 1}^{M} {P}_{C , B} ( x , {\dot{y}}_{m} )}$$
$$wherein$$
$${ψ}_{m} = exp ( - \frac{{d}_{m}}{τ max ( \vert y \vert , \vert {\dot{y}}_{m} \vert )} ) .$$

8. An electronic device, comprising:
a memory;
a modem; and
a processor connected to the modem and the memory,
wherein the processor is configured to:
receive a first speech signal, and
output a first text corresponding to the first speech signal from a pre-trained first artificial intelligence algorithm module using the first speech signal as input,
wherein the pre-trained first artificial intelligence algorithm module is pre-trained based on a first loss, and
wherein the first loss is determined based on a similarity between at least one speech embedding output from the first artificial intelligence algorithm module using a second speech signal as input and at least one text embedding output from a second artificial intelligence algorithm module using a second text as input.

9. The electronic device of claim 8,
wherein the first artificial intelligence algorithm module includes a CTC (connectionist temporal classification) model, and
wherein the second artificial intelligence algorithm module includes a BERT (bidirectional encoder representations from transformers) model.

10. The electronic device of claim 8,
wherein the first loss is determined based on a CTC-BERT score, which is determined based on an average value of the similarity between the at least one speech embedding and the at least one text embedding.

11. The electronic device of claim 8,
wherein the pre-trained first artificial intelligence algorithm module is further pre-trained based on the first loss and a second loss, and
wherein the second loss is determined based on a reference token sequence output from the first artificial intelligence algorithm module using the second speech signal as input.

12. The electronic device of claim 8,
wherein the second artificial intelligence algorithm module is pre-trained and has a fixed model parameter.

13. The electronic device of claim 8,
wherein the CTC-BERT score is determined as follows
$${R}_{C , B} ( x , y ) = \frac{1}{T} {\sum }_{{[ {h}^{X} ]}_{i} ∈ {h}^{X}} {max}_{{[ {h}^{Y} ]}_{j} ∈ {h}^{Y}} {Φ}_{ij} ,$$
$${P}_{C , B} ( x , y ) = \frac{1}{U} {\sum }_{{[ {h}^{Y} ]}_{j} ∈ {h}^{Y}} {max}_{{[ {h}^{X} ]}_{i} ∈ {h}^{X}} {Φ}_{ij} ,$$
$${Φ}_{ij} = \frac{{{[ {h}^{X} ]}_{i}^{T} [ {h}^{Y} ]}_{j}}{‖ {[ {h}^{X} ]}_{i} ‖ ‖ {[ {h}^{Y} ]}_{j} ‖}$$
wherein T represents a length of the second speech signal,
and wherein U represents a length of the second text.

14. The electronic device of claim 8,
wherein the first loss is determined by the following equation,
$${ℒ}_{CMWED} = {\sum }_{m = 1}^{M} - {p}_{m}^{ψ} log {p}_{m}^{{P}_{C , B}} ,$$
$${p}_{m}^{ψ} = \frac{{ψ}_{m}}{{\sum }_{i = 1}^{M} {ψ}_{i}} ,$$
$${p}_{m}^{{P}_{C , B}} = \frac{{P}_{C , B} ( x , {\dot{y}}_{m} )}{{\sum }_{i = 1}^{M} {P}_{C , B} ( x , {\dot{y}}_{i} )}$$
$$wherein$$
$${ψ}_{m} = exp ( - \frac{{d}_{m}}{τ max ( \vert y \vert , \vert {\dot{y}}_{m} \vert )} ) .$$

15. A program stored on a medium for performing speech recognition through an artificial intelligence algorithm executable by a processor, comprising:
receiving a first speech signal; and
outputting a first text corresponding to the first speech signal from a pre-trained first artificial intelligence algorithm module using the first speech signal as input,
wherein the pre-trained first artificial intelligence algorithm module is pre-trained based on a first loss, and
wherein the first loss is determined based on a similarity between at least one speech embedding output from the first artificial intelligence algorithm module using a second speech signal as input and at least one text embedding output from a second artificial intelligence algorithm module using a second text as input.
